(19) United States
(12) Patent Application Publication
(10) Pub. No.: US 2005/0052593 A1
(43) Pub. Date: Mar. 10, 2005

(54) Color filter for transflective liquid crystal display

(76) Inventors: Dai-Liang Ting, Hsinchu City (TW); Chi-Jian Wen, Hsinchu City (TW); Kuang-Lung Kuo, Jhongli City (TW)

Correspondence Address: FINNEGAN, HENDERSON, FARABOW, GARRETT & DUNNER;LLP, 1300 I STREET, NW, WASHINGTON, DC, 20005, US

(21) Appl. No.: 10/899,173

(22) Filed: Jul. 27, 2004

(30) Foreign Application Priority Data
Apr. 21, 2003 (IL) 155525

(51) Int. Cl. G02F 1/1335

(52) U.S. Cl. 349/109; 349/114

(57) ABSTRACT

A liquid crystal display device that includes a first substrate, a reflector formed over the first substrate, a second substrate spaced apart from the first substrate, an electrode layer formed over the second substrate, a light source disposed on a side of the first substrate opposite the second substrate, a color filter layer, formed between the electrode layer and the second substrate, including a reflection section for transmitting ambient light incident upon the second substrate and reflected by the reflector, and a transmission section for transmitting light emitted from the light source to the second substrate through the first substrate, and an optically transparent film formed in the reflection section, wherein the color filter layer disposed at the transmission section has a thickness greater than approximately 1.5 times that of the color filter layer disposed at the reflection section.

### DESCRIPTION

1. Technical Field

This invention pertains in general to a liquid crystal display (“LCD”) and, more particularly, to a transflective LCD including a color filter layer having an optically transparent film corresponding to a reflection section.

2. Background

An LCD device includes an LCD panel for display. However, unlike a cathode ray tube (“CRT”) display or an electroluminescence (“EL”) display, the liquid crystal display panel does not itself emit light. Some LCD devices require an additional light emitting device as a light source, while others may use ambient light instead. Depending on the way a light source is provided, LCD devices usually may be divided into three types: a transmission type, a reflective type and a “transflective” type.

A transmission-type LCD generally refers to one using an illuminator called “backlight” disposed at the rear or back side of an LCD panel. The backlight is responsible for 50% or more of the total power consumption in transmission-type LCDs. That is, the transmission-type LCDs consume a large amount of power to keep the backlight active. Besides, the transmission-type LCDs may have poor display quality in a light-intensive environment.

A reflective-type LCD generally refers to one using ambient light, for example, direct sunlight or indoor luminescent light, as a light source. Reflective-type LCDs are provided with a reflector to reflect ambient light, which eliminates the need for a backlight, and the associated power consumption. Reflective-type LCDs sometimes suffer from low luminescence.

A transflective-type LCD generally refers to one that is partly transmissive and partly reflective, and thus includes a backlight source and a reflector. Transflective-type LCDs are advantageous because they may be implemented in any environment regardless of light intensities. Examples of conventional LCD devices of the transflective type include U.S. Pat. No. 6,195,140 to Kubo et al., entitled “LIQUID CRYSTAL DISPLAY IN WHICH AT LEAST ONE PIXEL INCLUDES BOTH A TRANSMISSIVE REGION AND A REFLECTIVE REGION,” and U.S. Pat. No. 6,281,952 to Okamoto et al., entitled “LIQUID CRYSTAL DISPLAY.”

In the conventional transflective-type LCD, ambient light incident upon the LCD panel is transmitted to and reflected by the reflector. That is, the incident ambient light passes through the color filter layer of the LCD panel twice. On the other hand, the light emitted from the backlight source only passes through the color filter layer once. As a result, the conventional transflective-type LCD devices may exhibit a difference in color, which may be sensitive to human eyes.

### SUMMARY OF THE INVENTION

Accordingly, the present invention is directed to LCD devices and methods that obviate one or more of the problems due to limitations and disadvantages of the related art.

Additional features and advantages of the present invention will be set forth in the description which follows, and in part will be apparent from the description, or may be learned by practice of the invention. The objectives and other advantages of the invention will be realized and attained by the devices and methods particularly pointed out in the written description and claims thereof, as well as the appended drawings.

To achieve these and other advantages, and in accordance with the purpose of the invention as embodied and broadly described, there is provided a liquid crystal display device that includes a first substrate, a reflector formed over the first substrate, a second substrate spaced apart from the first substrate, an electrode layer formed over the second substrate, a light source disposed on a side of the first substrate opposite the second substrate, a color filter layer, formed between the electrode layer and the second substrate, including a reflection section for transmitting ambient light incident upon the second substrate and reflected by the reflector, and a transmission section for transmitting light emitted from the light source to the second substrate through the first substrate, and an optically transparent film formed in the reflection section, wherein the color filter layer disposed at the transmission section has a thickness greater than that of the color filter layer disposed at the reflection section.

In one aspect, the color filter layer disposed at the transmission section has a thickness equal to or greater than approximately 1.5 times that of the color filter layer disposed at the reflection section.

In another aspect, the color filter layer disposed at the transmission section has a thickness equal to or smaller than approximately 2 times of the color filter layer disposed at the reflection section.

Also in accordance with the present invention, there is provided a liquid crystal display device that includes an insulating substrate, a color filter layer, formed on the insulating substrate, including at least one reflection section, an optically transparent film formed in the reflection section, and an electrode layer formed on the color filter layer, wherein the color filter layer disposed between the insulating substrate and the electrode layer has a thickness greater than that of the color filter layer disposed between the optically transparent film and the electrode layer.

In one aspect, the optically transparent film is a photo-senstive resin.

In another aspect, the optically transparent film includes a plurality of beads to diffuse light.

Further in accordance with the present invention, there is provided with a method of fabricating a liquid crystal display that includes providing an insulating substrate, forming an optically transparent film on the insulating substrate, forming a plurality of openings in the optically transparent film, providing a color filter layer on the insulating substrate, providing an electrode layer on the color filter layer, and providing the color filter layer between the transparent film and the electrode layer with a thickness smaller than that of the color filter layer disposed between the insulating substrate and the electrode layer.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate embodiments consistent with the invention and, together with the description, serve to explain the objects, advantages, and principles of the invention.

In the drawings,

FIG. 1A shows a cross-sectional view of an LCD in accordance with one embodiment of the present invention;

FIG. 1B shows a top view of a reflection section and a transmission section of the LCD shown in FIG. 1A;

FIG. 2 shows a cross-sectional view of a liquid crystal layer of an LCD in accordance with another embodiment of the present invention; and

FIG. 3 shows a cross-sectional view of a liquid crystal layer of an LCD in accordance with still another embodiment of the present invention.

### DESCRIPTION OF THE EMBODIMENTS

Reference will now be made in detail to embodiments consistent with the invention, examples of which are illustrated in the accompanying drawings. Wherever possible, the same reference numbers will be used throughout the drawings to refer to the same or like parts.

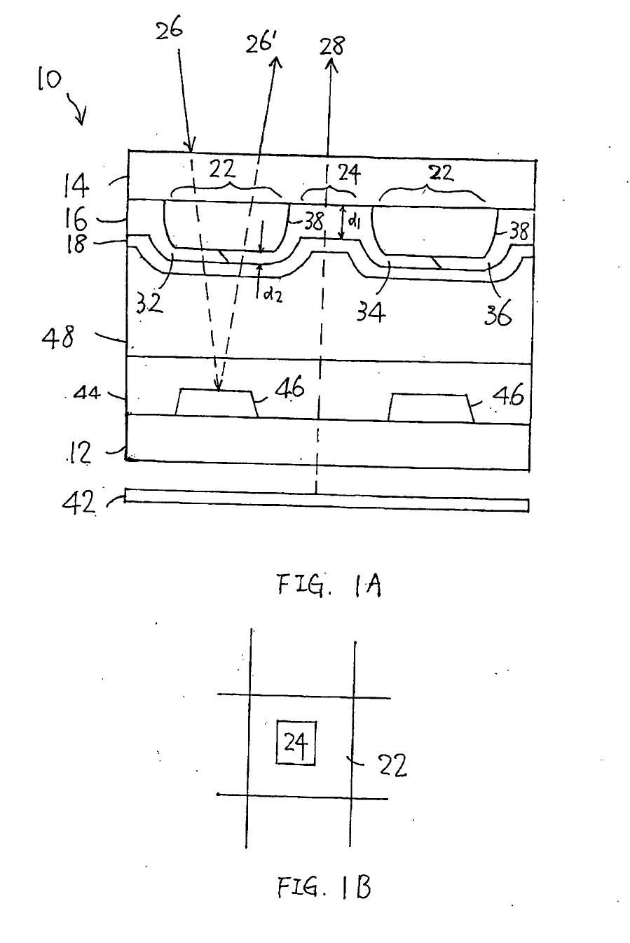

FIG. 1A shows a cross-sectional view of an LCD 10 in accordance with one embodiment of the present invention. Referring to FIG. 1A, LCD 10 includes a first substrate 12, a second substrate 14 spaced apart from first substrate 12, a color filter layer 16 formed between first substrate 12 and second substrate 14, and an electrode layer 18 formed on color filter layer 16. First substrate 12 and second substrate 14 are made of an electrically insulating and optically transparent material, for example, glass, quartz or the like. Color filter layer 16 may be defined to include at least one reflection section 22 and at least one transmission section 24 in a pixel (not shown) composed of three sub-pixels 32, 34 and 36, which may correspond to a red (R), a green (G) and a blue (B) pigment, respectively. Electrode layer 18 is made of an optically transparent material, for example, indium tin oxide (“ITO”). Reflection section 22 and transmission section 24 serve to provide the functions of a reflective-type LCD and a transmission-type LCD, respectively.

Color filter layer 16 includes an optically transparent film 38 formed in reflection section 22 such that color filter layer 16 disposed at transmission section 24 has a thickness d₁ greater than a thickness d₂ of color filter layer 16 disposed at reflection section 22. In one embodiment, d₁ is equal to or greater than approximately 1.5 times of d₂ (d₁>1.5d₂). In another embodiment, d; is equal to or smaller than approximately 2 times of d₂ (d₁<2d₂). The ratio of d₁ over d₂ may be adjusted by changing some of the characteristics of color filter layer 16, for example, viscosity. Optically transparent film 38, in one embodiment, is a photoresist.

LCD 10 also includes an active matrix layer 44 formed on first substrate 12, at least one reflector or a reflection film 46 formed in active matrix layer 44, and a liquid crystal layer 48 provided between active matrix layer 44 and color filter layer 16. In one embodiment, reflector 46 is made of metal, for example, aluminum or silver. In another embodiment, reflector 46 is a dielectric multi-layer film mirror. Ambient light 26 incident upon second substrate 14 is transmitted through optically transparent film 38, color filter layer 16, electrode layer 18, and liquid crystal layer 48 to reflector 46. Most of the ambient light 26 is reflected by reflector 46. A reflected ambient light 26′ is transmitted through liquid crystal layer 48, electrode layer 18, color filter layer 16, optically transparent film 38, and second substrate 14 to the human eyes for viewing. On the other hand, light 28 emitted from a backlight source 42 disposed on a side of first substrate 12 opposite second substrate 14 is transmitted through first substrate 12, liquid crystal layer 48, electrode layer 18, color filter layer 16, and second substrate 14 to the human eyes for viewing. Since d₂ is made smaller than d, in accordance with the embodiments of the present invention, a difference in color between reflected ambient light 26′ that passes through color filter layer 16 twice and light 28 that passes through color filter layer 16 once may be reduced.

FIG. 1B shows a top view of reflection section 22 and transmission section 24 of liquid crystal layer 16 shown in FIG. 1A. Referring to FIG. 1B, transmission section 24 is surrounded by reflection section 22.

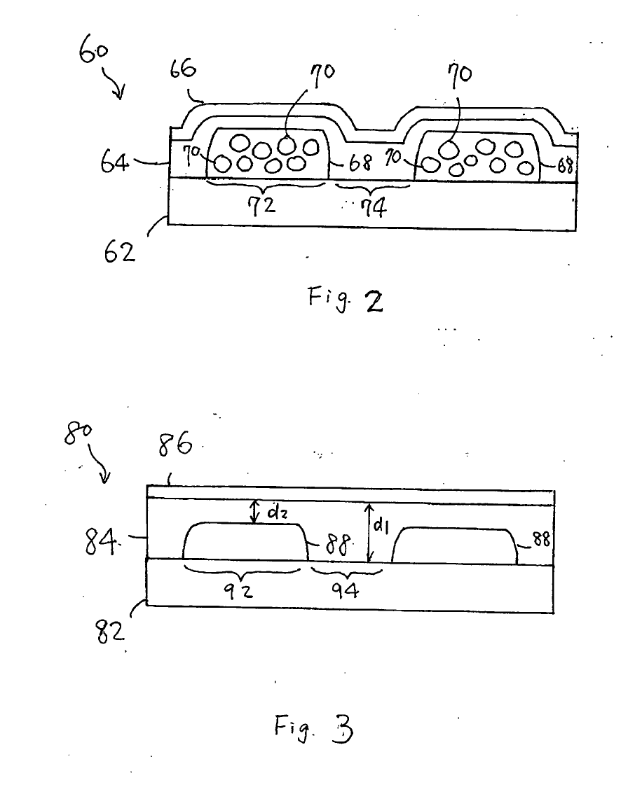

FIG. 2 shows a cross-sectional view of an LCD 60 in accordance with another embodiment of the present invention. Referring to FIG. 2, LCD 60 includes an insulating substrate 62, a color filter layer 64 formed on insulating substrate 62 and an electrode layer 66 formed on color filter layer 64. Color filter layer 64 may be defined to include at least one reflection section 72 and at least one transmission section 74 in a pixel (not shown). Color filter layer includes an optically transparent film 68 formed in reflection section 72. Optically transparent film 68 includes a plurality of beads 70 to diffuse light. In one embodiment, beads 70 are made of glass or any material capable of light diffusion.

FIG. 3 shows a cross-sectional view of an LCD 80 in accordance with still another embodiment of the present invention. Referring to FIG. 3, LCD 80 includes an insulating substrate 82, a color filter layer 84 formed on insulating substrate 82 and an electrode layer 86 formed on color filter layer 84. Color filter layer 84 may be defined to include at least one reflection section 92 and at least one transmission section 94 in a pixel (not shown) and has a substantially uniform surface. Color filter layer 84 includes an optically transparent film 88 formed on reflection section 92 such that color filter layer 84 disposed between insulating substrate 82 and electrode layer 86 has a thickness d₁ greater than a thickness d₂ of color filter layer 84 disposed between optically transparent film 88 and electrode layer 86. In one embodiment, d; is equal to or greater than approximately 1.5 times of d₂ (d₁>1.5d₂). In another embodiment, d₁ is equal to or smaller than approximately 2 times of d₂ (d₁<2d₂).

The present invention also includes a method of fabricating an LCD. The method includes providing an insulating substrate, for example, an optically transparent substrate made of glass, quartz or the like. An optically transparent film is then formed on the insulating substrate. Subsequently, a plurality of openings are formed in the optically transparent film. A color filter layer is provided on the insulating substrate before an electrode layer is provided on the color filter layer. The method provides the color filter layer disposed between the transparent film and the electrode layer with a thickness d₁ greater than a thickness d₂ of the color filter layer disposed between the insulating substrate and the electrode layer. In one embodiment, d₁ is equal to or greater than approximately 1.5 times of d₂ (d₁>1.5d₂). In another embodiment, d₁ is equal to or smaller than approximately 2 times of d₂ (d₁<2d₂).

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A liquid crystal display device, comprising:
a first substrate;
a plurality of pixels comprising a reflection section and a transmission section formed over the first substrate;
a second substrate spaced apart from the first substrate;
a transparent electrode layer formed over the second substrate;
a light source disposed on a side of the first substrate opposite the second substrate;
a color filter layer, formed between the transparent electrode layer and the second substrate, and
an optically transparent film formed between the color filter layer and the second substrate in the reflection section,
wherein the color filter layer disposed at the transmission section has a thickness equal to or greater than approximately 1.5 times that of the color filter layer disposed at the reflection section.

2. The device of claim 1, wherein the color filter layer disposed at the transmission section has a thickness equal to or smaller than approximately 2 times that of the color filter layer disposed at the reflection section.

3. The device of claim 1, wherein the optically transparent film includes a photoresist.

4. The device of claim 1, wherein the optically transparent film includes a plurality of beads to diffuse light.

5. A liquid crystal display device, comprising:
an insulating substrate;
a color filter layer, formed on the insulating substrate, including at least one reflection section;
an optically transparent film formed in the reflection section; and
an electrode layer formed on the color filter layer,
wherein the color filter layer disposed between the insulating substrate and the electrode layer has a thickness equal to or greater than approximately 1.5 times that of the color filter layer disposed between the optically transparent film and the electrode layer.

6. The device of claim 5, wherein the color filter layer disposed between the insulating substrate and the electrode layer has a thickness equal to or smaller than approximately 2 times that of the color filter layer disposed between the optically transparent film and the electrode layer.

7. The device of claim 5, wherein the insulating substrate is a first substrate, and wherein the device further includes a second substrate spaced apart from the first substrate, a reflector formed over the second substrate, and a light source disposed on a side of the second substrate opposite the first substrate.

8. The device of claim 7, wherein an incident ambient light is transmitted through the first substrate, the optically transparent film, the color filter layer and the electrode layer to the reflector.

9. The device of claim 8, wherein the incident ambient light reflected by the reflector is transmitted through the electrode layer, the color filter layer, the optically transparent film and the first substrate.

10. The device of claim 7, wherein the color filter layer includes at least one transmission section.

11. The device of claim 10, wherein light emitted from the light source is transmitted through the second substrate, the electrode layer, the transmission section, the color filter layer and the first substrate.

12. The device of claim 5, wherein the optically transparent film includes a photoresist.

13. The device of claim 5, wherein the optically transparent film includes a plurality of beads to diffuse light.

14. A method of fabricating a liquid crystal display, comprising:
providing an insulating substrate;
forming an optically transparent film on the insulating substrate;
patterning the optically transparent film;
providing a color filter layer on the insulating substrate;
providing an electrode layer on the color filter layer; and
wherein the color filter layer is disposed between the insulating substrate and the electrode layer with a thickness equal to or greater than approximately 1.5 times that of the color filter layer disposed between between the optically transparent film and the electrode layer.

15. The method of claim 14, wherein the color filter layer is disposed between the insulating substrate and the electrode layer with a thickness equal to or smaller than approximately 2 times that of the color filter layer disposed between between the optically transparent film and the electrode layer.

16. The method of claim 15, further comprising providing the optically transparent film with a plurality of beads to diffuse light.
